(19) United States
(12) Patent Application Publication
(10) Pub. No.: US 2013/0215549 A1
(43) Pub. Date: Aug. 22, 2013

(54) POWER-SUPPLY CONTROL DEVICE

(71) Applicants: Takashi Aragai, Aichi (JP); Yusuke Ukai, Aichi (JP); Hirohito Miyazaki, Gifu (JP)

(72) Inventors: Takashi Aragai, Aichi (JP); Yusuke Ukai, Aichi (JP); Hirohito Miyazaki, Gifu (JP)

(21) Appl. No.: 13/772,013

(22) Filed: Feb. 20, 2013

(30) Foreign Application Priority Data
Feb. 20, 2012 (JP) 2012-033637

(51) Int. Cl. H01H 47/22

(52) U.S. Cl. CPC H01H 47/22
USPC 361/160

(57) ABSTRACT

Power consumption of a relay that switches electric connection between a power supply and a load of a vehicle is suppressed. When receiving a disconnection instruction signal from a control circuit, a disconnection circuit transmits a disconnection signal to a coil of a keep relay, and brings a movable contact into contact with a contact to electrically disconnect the power supply from the load. When receiving a connection instruction signal from the control circuit, a connection circuit transmits a connection signal to a coil of the keep relay, and brings the movable contact into contact with a contact to electrically connect the power supply to the load. An automatic stopping circuit stops the connection signal output from the connection circuit using a voltage or a current supplied from the keep relay to the load. For example, the present invention can be applied to a power-supply control device for the vehicle.

### CROSS-REFERENCE TO RELATED APPLICATIONS

The present application claims priority from Japanese Patent Application No. 2012-033637, filed Feb. 20, 2012. The content of the priority application is hereby incorporated by reference in its entirety.

### BACKGROUND OF INVENTION

1. Field of Invention

One or more embodiments of the present invention relates to a power-supply control device, particularly to a power-supply control device that controls supply of an electric power to a vehicle load.

2. Background Art

For example, Japanese Unexamined Patent Publication Nos. 2008-290604 and 2003-235155 disclose a technology, in which a keep relay is provided between a battery and the load (for example, an ECU) of the vehicle and the keep relay is opened by a predetermined manipulation to prevent a discharge of a battery due to passage of a dark current during transportation of the vehicle or long-term parking.

For example, Japanese Unexamined Patent Publication No. 2000-50513 discloses a technology, in which a usual in-vehicle relay and a keep relay are provided between the load and the battery of the vehicle, reliability of electric power supply is improved by turning both the in-vehicle relay and the keep relay during turn-on of an ignition, and power consumption is reduced by turning only on the keep relay during turn-off of the ignition.

Because of the large power consumption of the coil that is used to switch between the contacts of the keep relay, there is a demand to shorten a time for which a control signal is transmitted to keep relay in order to control a state of the contact as much as possible, and that the power consumption of the keep relay is reduced to suppress the consumption of the electric power of the battery.

### SUMMARY OF INVENTION

One or more embodiments of the present invention may suppress the power consumption when the relay is used to switch the electric connection between the power supply and the load of the vehicle.

In accordance with one aspect of the present invention, a power-supply control device that controls supply of an electric power from a power supply of a vehicle to a load of the vehicle by controlling a relay, the relay switching electric connection between the power supply and the load, the relay being able to retain a state of a contact even if transmission of a control signal is stopped, the power-supply control device includes: a control circuit that controls the state of the contact of the relay; a connection circuit that transmits a first control signal to the relay in order to put the contact of the relay into a first state in which the power supply and the load are connected to each other when the control circuit transmits a first instruction signal; a disconnection circuit that transmits a second control signal to the relay in order to put the contact of the relay into a second state in which the power supply and the load are disconnected from each other when the control circuit transmits a second instruction signal; and an automatic stopping circuit that is connected between the relay and the load, and stops the first control signal output from the connection circuit using a voltage or a current, which is supplied from the relay to the load.

In the power-supply control device in accordance with one aspect of the present invention, the control circuit controls the state of the contact of the relay, which switches the electric connection between the power supply and the load of the vehicle and is able to retain the state of the contact even if the transmission of the control signal is stopped. When the control circuit transmits the first instruction signal, the first control signal is transmitted to the relay in order to put the contact of the relay into the first state in which the power supply and the load are connected to each other. When the control circuit transmits the second instruction signal, the second control signal is transmitted to the relay in order to put the contact of the relay into the second state in which the power supply and the load are disconnected from each other. The first control signal output from the connection circuit is stopped using the voltage or the current, which is supplied from the relay to the load.

Accordingly, the power consumption can be suppressed when the relay is used to switch the electric connection between the power supply and the load of the vehicle.

For example, the relay is constructed by a keep relay. For example, the control circuit is constructed by a processor, such as a CPU, or an arithmetic device. For example, the connection circuit, the disconnection circuit, and the automatic stopping circuit are constructed by an electric circuit in which the switching element is used.

In the power-supply control device, the automatic stopping circuit may stop the first control signal output from the connection circuit by stopping the connection circuit input to the first instruction signal.

Therefore, for example, the output of the first control signal can surely be stopped even if the first instruction signal output from the control circuit cannot be stopped.

In the power-supply control device, the connection circuit may include a first switching element that becomes an on state only while the control circuit transmits the first instruction signal, the first switching element causing the connection circuit to output the first control signal, and the automatic stopping circuit includes a second switching element that becomes the on state using the voltage or the current, which is supplied from the relay to the load, the second switching element putting the first switching element into an off state by conducting the first instruction signal output from the control circuit to the automatic stopping circuit before the first instruction signal is input to the connection circuit.

Therefore, the output of the first control signal can rapidly be stopped.

In the power-supply control device, the second switching element may connect wiring between the control circuit and the first switching element to a ground when being in the on state.

Therefore, the output of the first control signal can surely be stopped.

In the power-supply control device, the relay may include a first coil and a second coil, the connection circuit is connected so as to transmit the first control signal to the first coil, the disconnection circuit is connected so as to transmit the second control signal to the second coil, and the relay becomes the first state when the first control signal is transmitted to the first coil, the relay maintaining the first state even if the transmission of the first control signal is stopped, and the relay becomes the second state when the second control signal is transmitted to the second coil, the relay maintaining the second state even if the transmission of the second control signal is stopped.

Therefore, the electric power consumed by the coil of the relay can be suppressed.

The power-supply control device may further include the relay.

According to one aspect of the present invention, the power consumption can be suppressed when the relay is used to switch the electric connection between the power supply and the load of the vehicle.

### BRIEF DESCRIPTION OF THE DRAWINGS

FIG. 1 is a block diagram illustrating a power-supply control device according to one or more embodiments of the present invention;

FIG. 2 is a circuit diagram illustrating a power-supply management ECU of a first specific example according to one or more embodiments of the present invention;

FIG. 3 is a view illustrating an operation of the power-supply management ECU when supply of an electric power to a load is stopped according to one or more embodiments of the present invention;

FIG. 4 is a view illustrating an operation of the power-supply management ECU when the supply of the electric power to the load is started according to one or more embodiments of the present invention; and

FIG. 5 is a circuit diagram illustrating a power-supply management ECU of a second specific example according to one or more embodiments of the present invention.

### DETAILED DESCRIPTION

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention. Hereinafter, embodiments of the present invention will be described. The description is made as follows.

1. Embodiments

2. Modifications

### 1. Embodiments

### [Configuration Example of Power-Supply Control Device 101]

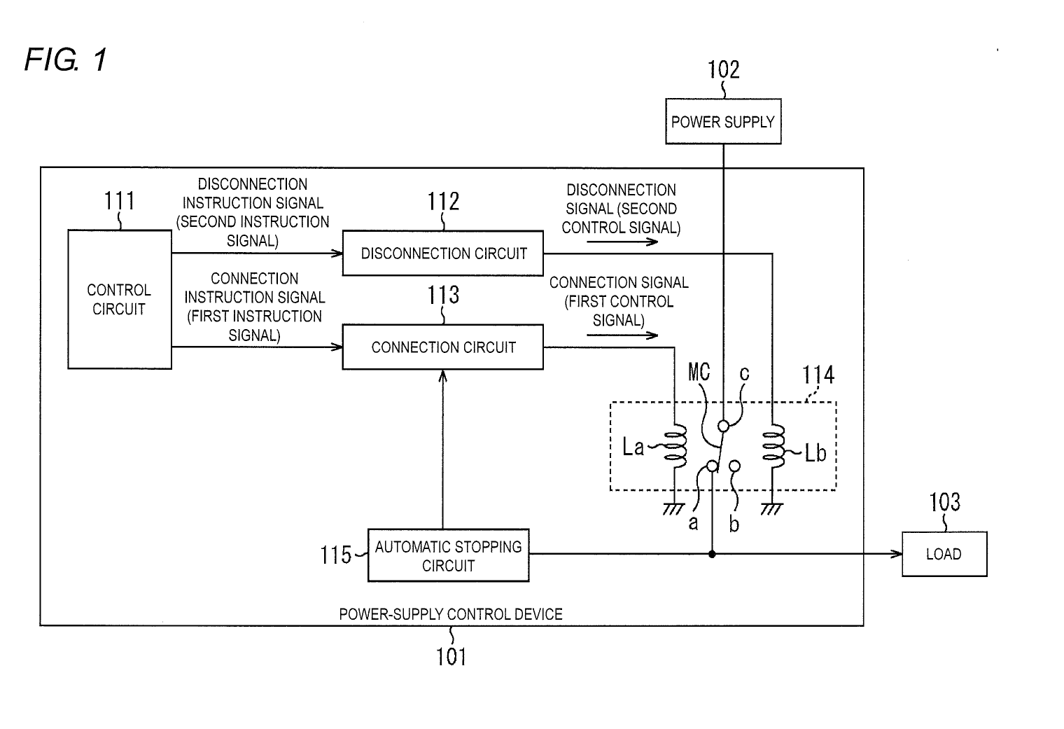

FIG. 1 is a block diagram illustrating a power-supply control device 101 that is of a basic configuration example according to one or more embodiments of the present invention.

For example, the power-supply control device 101 is provided in a vehicle, and supplies an electric power from a power supply 102 to a load 103 of the vehicle. There is no particular limitation to a kind of a power supply system of the vehicle controlled by the power-supply control device 101. For example, a +B power supply, an ACC (accessory) power supply, and an IG (ignition) power supply can be cited as an example of the power supply system.

For example, the power supply 102 is constructed by a battery.

The load 103 is constructed by general in-vehicle loads, such as a heater, a lamp, a wiper, and an ECU (Electronic Control Unit), which are driven by an electric power of the power supply 102.

The power-supply control device 101 includes a control circuit 111, a disconnection circuit 112, a connection circuit 113, a keep relay 114, and an automatic stopping circuit 115.

The control circuit 111 controls a state of a contact of the keep relay 114 through the disconnection circuit 112 and the connection circuit 113, thereby controlling supply of the electric power from the power supply 102 to the load 103.

Specifically, in the case that the supply of the electric power from the power supply 102 to the load 103 is stopped, the control circuit 111 transmits a control signal (hereinafter referred to as a disconnection instruction signal) to disconnection circuit 112 in order to issue an instruction to electrically disconnect the power supply 102 from the load 103. When receiving the disconnection instruction signal, the disconnection circuit 112 transmits a control signal (hereinafter referred to as a disconnection signal) to a coil Lb of the keep relay 114 to bring a movable contact MC of the keep relay 114 into contact with a contact b. Therefore, the power supply 102 is electrically disconnected from the load 103 to stop the supply of the electric power from the power supply 102 to the load 103.

In the case that the supply of the electric power from the power supply 102 to the load 103 is started, the control circuit 111 transmits a control signal (hereinafter referred to as a connection instruction signal) to the connection circuit 113 in order to issue an instruction to electrically connect the power supply 102 to the load 103. When receiving the connection instruction signal, the connection circuit 113 transmits a control signal (hereinafter referred to as a connection signal) to a coil La of the keep relay 114 to bring a movable contact MC of the keep relay 114 into contact with a contact a. Therefore, the power supply 102 is electrically connected to the load 103 to start the supply of the electric power from the power supply 102 to the load 103.

The automatic stopping circuit 115 is operated by partially supplying the electric power (a voltage and a current) supplied from the keep relay 114 to the load 103, and the automatic stopping circuit 115 stops the connection signal output from the connection circuit 113.

### [Configuration Example of Power-Supply Management ECU 201]

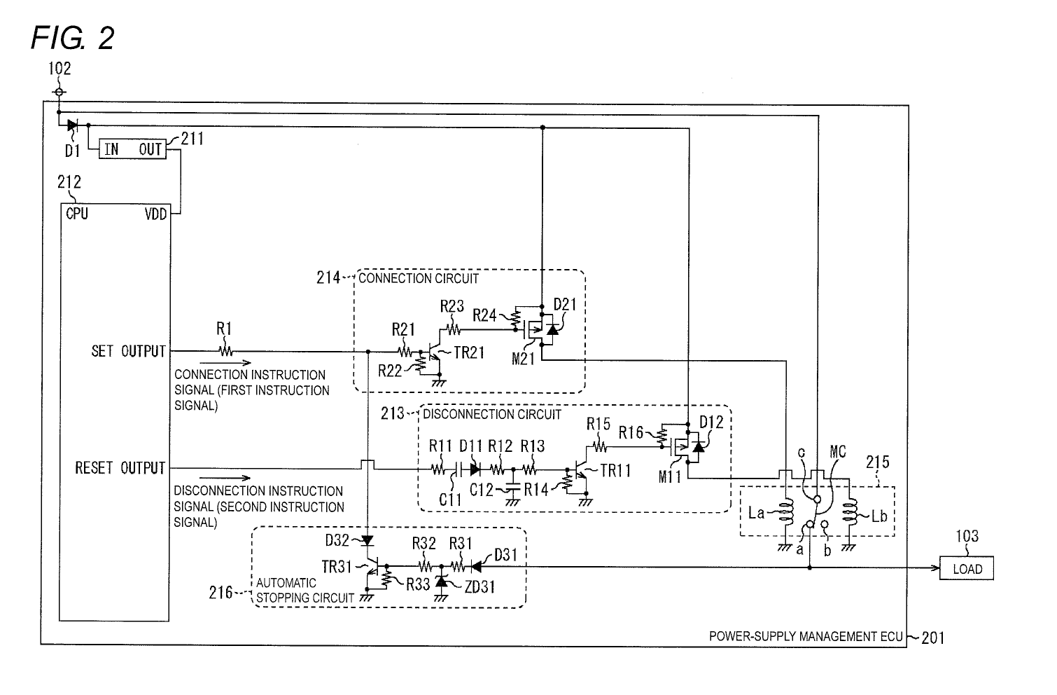

FIG. 2 is a circuit diagram illustrating a configuration example of a power-supply management ECU (Electronic Control Unit) 201 that is of a first specific example of the power-supply control device 101 in FIG. 1.

The power-supply management ECU 201 includes a voltage regulator 211, a CPU (Central Processing Unit) 212, a disconnection circuit 213, a connection circuit 214, a keep relay 215, an automatic stopping circuit 216, a diode D1, and a resistor R1.

The power supply 102 is connected to an anode of the diode D1 and a terminal c of the keep relay 215. A cathode of the diode D1 is connected to an input terminal (IN) of the voltage regulator 211, a source of a MOSFET M11 of the disconnection circuit 213, and a source of a MOSFET M21 of the connection circuit 214.

An output terminal (OUT) of the voltage regulator 211 is connected to a power supply terminal (VDD) of the CPU 212. The voltage regulator 211 converts the voltage (for example, DC12 V) of the electric power supplied from the power supply 102 into a predetermined voltage (for example, DC5 V), and supplies the converted voltage to the CPU 212.

A reset output terminal (RESET OUTPUT) of the CPU 212 is connected to one end of a resistor R11 of the disconnection circuit 213. In the case that the supply of the electric power from the power supply 102 to the load 103 is stopped, the pulsed disconnection instruction signal is continuously output from the reset output terminal, and transmitted to the disconnection circuit 213.

A set output terminal (SET OUTPUT) of the CPU 212 is connected to one end of a resistor R21 of the connection circuit 214 through the resistor R1. In the case that the supply of the electric power from the power supply 102 to the load 103 is started, the single pulsed connection instruction signal is output from the set output terminal of the CPU 212, and transmitted to the connection circuit 214.

The disconnection circuit 213 includes resistors R11 to R16, capacitors C11 and C12, diodes D11 and D12, an NPN-type transistor TR11, and the P-type MOSFET M11.

The resistor R11 and the capacitor C11 are connected in series between the reset output terminal of the CPU 212 and the anode of the diode D11. The resistors R12 and R13 are connected in series between the cathode of the diode D11 and a base of the transistor TR11. One end of the capacitor C12 is connected between the resistors R12 and R13, and the other end is connected to the ground. A collector of the transistor TR11 is connected to a gate of the MOSFET M11 through the resistor R15, an emitter of the transistor TR11 is connected to the ground, and the resistor R14 is connected between the base and the emitter. A drain of the MOSFET M11 is connected to the anode of the diode D12 and one end of the coil Lb of the keep relay 215, a source of the MOSFET M11 is connected to the cathode of the diode D12, and the resistor R16 is connected between the gate and the source.

An operation of the disconnection circuit 213 is described later.

The connection circuit 214 includes resistors R21 to R24, a diode D21, an NPN-type transistor TR21, and a P-type MOSFET M21.

The base of the transistor TR21 is connected to the set output terminal of the CPU 212 through the resistors R1 and R21, the collector is connected to the gate of the MOSFET M21 through the resistor R23, and the emitter is connected to the ground, and the resistor R22 is connected between the base and the emitter. The drain of the MOSFET M21 is connected to the anode of the diode D21 and one end of the coil La of the keep relay 215, the source is connected to the cathode of the diode D21, and the resistor R24 is connected between the gate and the source.

An operation of the connection circuit 214 is described later.

The automatic stopping circuit 216 includes diodes D31 and D32, resistors R31 to R33, a Zener diode ZD31, and an NPN-type transistor TR31.

The anode of the diode D31 is connected between the contact a of the keep relay 215 and the load 103. The resistors R31 and R32 are connected in series between the cathode of the diode D31 and the base of the transistor TR31. The cathode of the Zener diode ZD31 is connected between the resistors R31 and R32, and the anode is connected to the ground. The collector of the transistor TR31 is connected to the cathode of the diode D32, the emitter is connected to the ground, and the resistor R33 is connected between the base and the emitter. The anode of the diode D32 is connected to the wiring between the set output terminal of the CPU 212 and the connection circuit 214, more correctly the wiring between the resistor R1 and the resistor R21 of the connection circuit 214.

### [Operation of Power-Supply Management ECU 201]

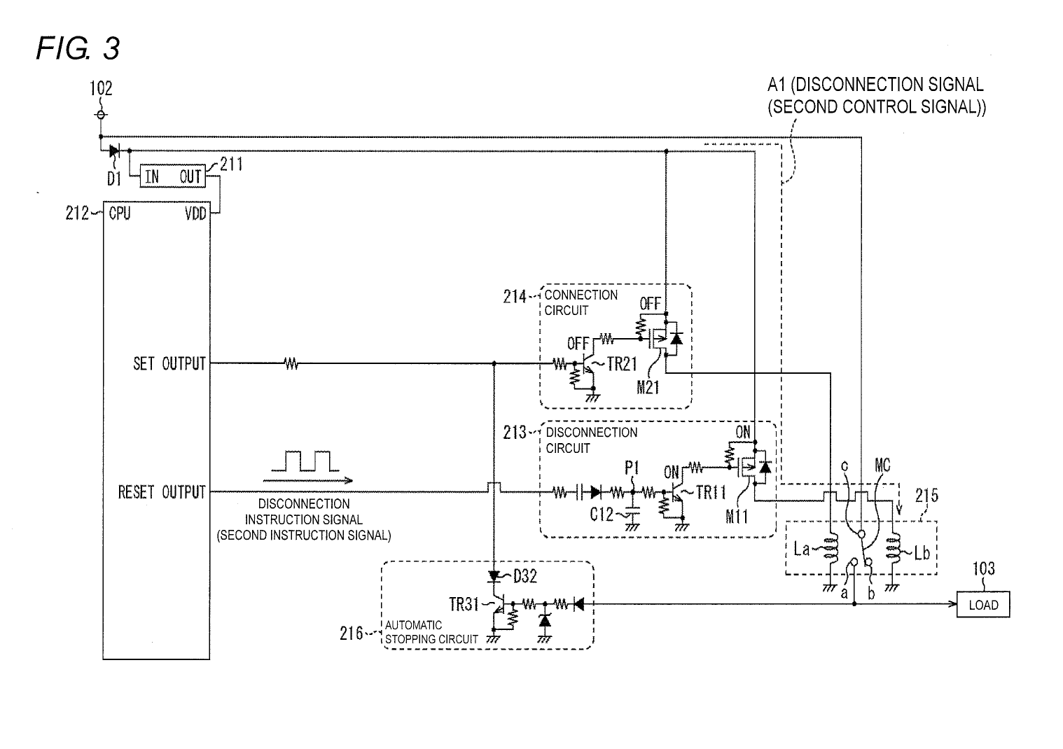

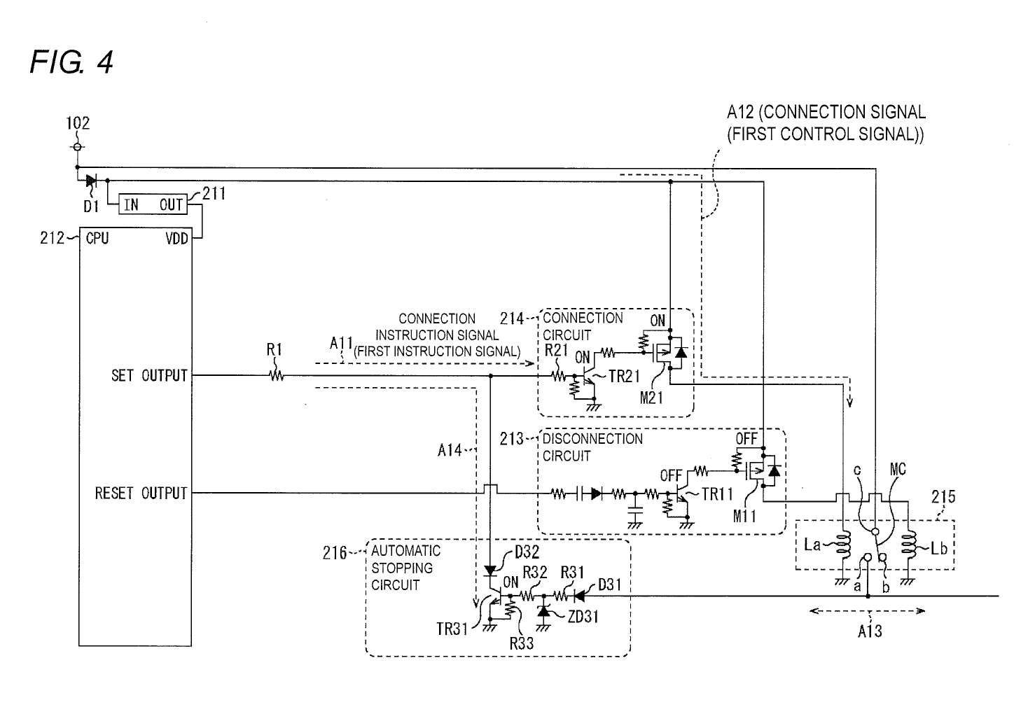

An operation of the power-supply management ECU 201 will be described below with reference to FIGS. 3 and 4. In FIGS. 3 and 4, the signs are partially omitted for the sake of convenience.

(The Case that Supply of Electric Power to Load 103 is Stopped)

The operation to stop the supply of the electric power from the power supply 102 to the load 103 will be described with reference to FIG. 3.

In the case that the supply of the electric power to the load 103 is stopped, the pulsed disconnection instruction signal having a positive-true logic (high active) is continuously output from the reset output terminal of the CPU 212. Every time the pulsed disconnection instruction signal is transmitted to the disconnection circuit 213, a charge is accumulated in the capacitor C12, and a potential at a point P1 rises. The predetermined number of pulsed disconnection instruction signals is transmitted to the disconnection circuit 213, a charge amount accumulated in the capacitor C12 is greater than or equal to a predetermined amount, and the potential at the point P1 is greater than or equal to a predetermined threshold. At this point, the transistor TR11 is turned on and therefore the MOSFET M11 is turned on.

When the MOSFET M11 is turned on, the excitation current is passed through the diode D1 and the MOSFET M11 from the power supply 102, and passed through the coil Lb of the keep relay 215 as indicated by an arrow A1. That is, the disconnection signal is output from the disconnection circuit 213, and transmitted to the coil Lb. When the disconnection signal is transmitted to the coil Lb for at least a predetermined time, the movable contact MC moves and comes into contact with the contact b. Therefore, the supply of the electric power from the power supply 102 to the load 103 is stopped.

The CPU 212 stops the output of the disconnection instruction signal after outputting the predetermined number of pulsed disconnection instruction signals. When the output of the disconnection instruction signal is stopped, the charge accumulated in the capacitor C12 is discharged, and the potential at the point P1 is gradually lowered. When the potential at the point P1 is less than the threshold, the transistor TR11 is turned off, and therefore the MOSFET M11 is turned off. Therefore, the transmission of the disconnection signal to the coil Lb is stopped.

The stop of the supply of the electric power to the load 103 is continued, because the contact of the movable contact MC of the keep relay 215 with the contact b is maintained even after the transmission of the disconnection signal is stopped.

Thus, the keep relay 215 can be set to the disconnection state as needed basis during the transportation of the vehicle or the long-period parking, and the dark current from the power supply 102 to the load 103 can be prevented.

Unless the predetermined number of pulsed disconnection instruction signals is transmitted to the disconnection circuit 213, the disconnection circuit 213 does not output the disconnection signal. Therefore, the false stop of the supply of the electric power to the load 103 due to a noise is prevented.

(The Case that Supply of Electric Power to Load 103 is Started)

The operation to start the supply of the electric power from the power supply 102 to the load 103 will be described below with reference to FIG. 4.

In the case that the supply of the electric power to the load 103 is started, (the current of) the connection instruction signal having a positive-true logic (high active) is output from the set output terminal of the CPU 212, and transmitted to the connection circuit 214 as indicated by an arrow A11. While the connection signal is transmitted, the transistor TR21 is turned on, and therefore the MOSFET M21 is turned on.

When the MOSFET M21 is turned on, the excitation current is passed through the diode D1 and the MOSFET M21 from the power supply 102, and passed through the coil La of the keep relay 215 as indicated by an arrow A12. That is, the connection signal is output from the connection circuit 214, and transmitted to the coil La. When the connection signal is transmitted to the coil La for at least a predetermined time, the movable contact MC moves and comes into contact with the contact a. Therefore, the supply of the electric power from the power supply 102 to the load 103 is started as indicated by an arrow A13.

At this point, as indicated by the arrow A13, the electric power (the voltage and the current) supplied from the keep relay 215 to the load 103 is partially supplied to the automatic stopping circuit 216. The current is passed through the keep relay 215, the diode D31, and the resistors R31 and R32 from the power supply 102, and passed through the base of the transistor TR31, thereby turning on the transistor TR31. In other words, the transistor TR31 detects the supply of the electric power to the load 103.

When the transistor TR31 is turned on, the wiring between the set output terminal of the CPU 212 and the connection circuit 214 is connected to the ground through the diode D32 and the transistor TR31. As a result, as indicated by an arrow A14, the connection instruction signal output from the set output terminal of the CPU 212 is conducted to the automatic stopping circuit 216 before input to the connection circuit 214, and the connection instruction signal flows to the ground through the diode D32 and the transistor TR31. Therefore, the transmission of the connection instruction signal to the connection circuit 214 is stopped, the transistor TR21 is turned off, and the MOSFET M21 is also turned off, thereby stopping the transmission of the connection signal to the coil La.

The supply of the electric power to the load 103 is continued, because the movable contact MC remains to be in contact with the contact a even after the supply of the connection signal is stopped. The connection signal is not transmitted to the coil La of the keep relay 215, because the on state of the transistor TR31 of the automatic stopping circuit 216 is maintained while the supply of the electric power to the load 103 is continued.

Then the connection instruction signal output from the CPU 212 is stopped.

Thus, the CPU 212 outputs the connection instruction signal, the connection circuit 214 transmits the connection signal to the coil La of the keep relay 215, and the movable contact MC comes into contact with the contact a, thereby instantaneously stopping the transmission of the connection signal to the coil La. At this point, because a resistance component of a circuit constructed by the diode D32 and the transistor TR31 is smaller than that of the coil La, the power consumption in the case that the connection instruction signal flows to the ground through the diode D32 and the transistor TR31 is smaller than the power consumption in the case that the connection signal is transmitted to the coil La. As a result, the power consumption can be suppressed in the whole of the power-supply management ECU 201. Particularly, for example, the power consumption can effectively be reduced in the case that an output time of the connection instruction signal of the CPU 212 is lengthened or in the case that the output of the connection instruction signal is not stopped due to breakdown of the CPU 212.

[Configuration Example of Power-Supply Management ECU 301]

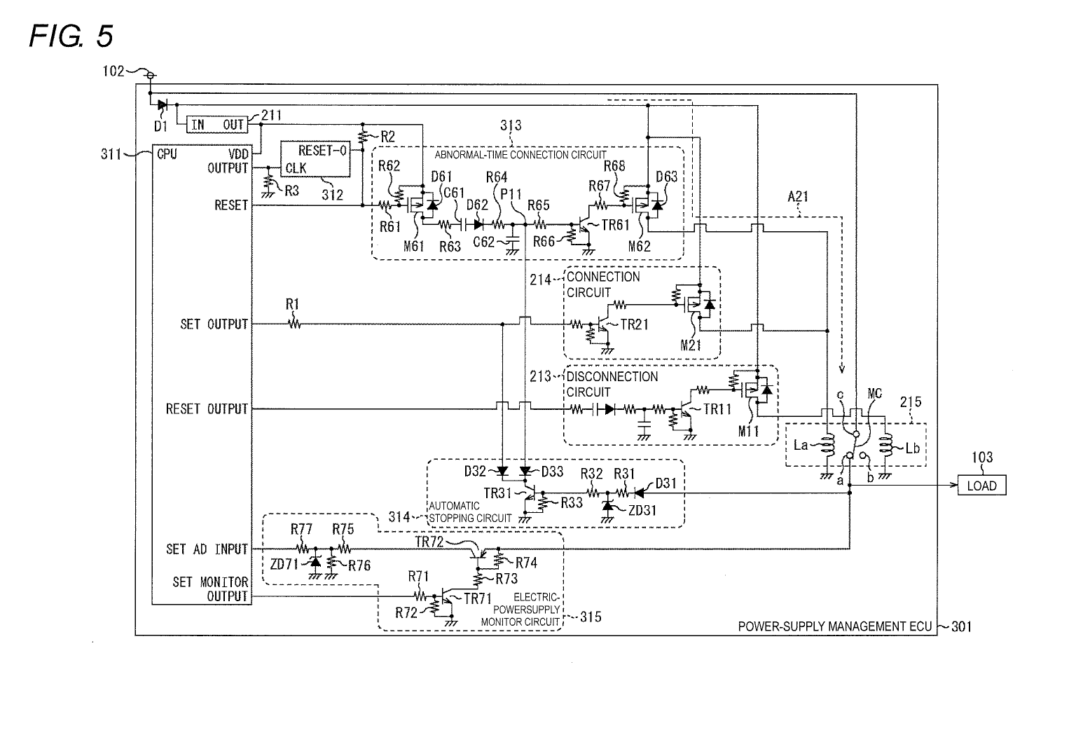

FIG. 5 is a circuit diagram illustrating a configuration example of a power-supply management ECU (Electronic Control Unit) 301 that is of a second specific example of the power-supply control device 101 in FIG. 1. In FIG. 5, the component corresponding to that in FIG. 2 is designated by the same sign (however, the signs are partially omitted for the sake of convenience), and the overlapping description of the portion having the same processing is omitted as appropriate.

The power-supply management ECU 301 differs from the power-supply management ECU 201 in FIG. 2 in that a CPU 311 is provided instead of the CPU 212, that an automatic stopping circuit 314 is provided instead of the automatic stopping circuit 216, and that a monitor circuit 312, an abnormal-time connection circuit 313, an electric-power supply monitor circuit 315, and resistors R2 and R3 are added.

The cathode of the diode D1 is connected to the input terminal (IN) of the voltage regulator 211, the source of the MOSFET M11 of the disconnection circuit 213, and the source of the MOSFET M21 of the connection circuit 214, and a source of a MOSFET M62 of the abnormal-time connection circuit 313.

The output terminal (OUT) of the voltage regulator 211 is connected to a power supply terminal (VDD) of the CPU 311, one end of the resistor R2, and a source of a MOSFET M61 of the abnormal-time connection circuit 313. The voltage regulator 211 converts the voltage (for example, DC12 V) of the electric power supplied from the power supply 102 into a predetermined voltage (for example, DC5 V), and supplies the converted voltage to the CPU 311 and the abnormal-time connection circuit 313.

The CPU 311 differs from the CPU 212 in FIG. 2 in that an output terminal (OUTPUT), a reset terminal (RESET), a monitoring setting output terminal (SET MONITOR OUTPUT), and a monitoring input terminal (SET AD INPUT) are added.

The output terminal of the CPU 311 is connected to a clock terminal (CLK) of the monitor circuit 312. One end of the resistor R3 is connected between the output terminal of the CPU 311 and the clock terminal of the monitor circuit 312, and the other end is connected to the ground. In the case that the CPU 311 is normally operated, the single pulsed clear signal is periodically output from the output terminal of the CPU 311, and transmitted to the monitor circuit 312. On the other hand, the output of the clear signal is stopped in the case that an abnormality is generated in the CPU 311.

The reset terminal of the CPU 311 is connected to a reset output terminal (RESET-O) of the monitor circuit 312, one end of the resistor R2, which is opposite to the end connected to the voltage regulator 211, and one end of a resistor R61 of the abnormal-time connection instruction circuit 313. When the reset signal is input to the reset terminal of the CPU 311 from the monitor circuit 312, the CPU 311 is reset to the initial state by performing restart.

The monitoring setting output terminal of the CPU 311 is connected to one end of a resistor R71 of the electric-power supply monitor circuit 315. In the case that the supply of the electric power to the load 103 is monitored, a checking instruction signal that is of the positive-true-logic (high-active) control signal is output from the monitoring setting output terminal, and transmitted to the electric-power supply monitor circuit 315.

The monitoring input terminal of the CPU 311 is connected to the one end of a resistor R77 of the electric-power supply monitor circuit 315. An electric-power supply monitor signal is input to the monitoring input terminal of the CPU 311. The electric-power supply monitor signal indicates existence or non-existence of the electric power supplied from the power supply 102 to the load 103 through the keep relay 215.

For example, the monitor circuit 312 is constructed by a WDT (watchdog timer) IC. The monitor circuit 312 is provided with a counter, and always performs counting during the operation. When the clear signal is input to the clock terminal from the CPU 311, the monitor circuit 312 resets the counter to restart the counting from the beginning.

On the other hand, when a value of the counter exceeds a predetermined threshold (that is, an exceedance is generated) while the clear signal is not input from the CPU 311 for a predetermined time, the monitor circuit 312 outputs the single pulsed reset signal having a negative-true logic (low active) from the reset output terminal, and transmits the single pulsed reset signal to the reset terminal of the CPU 311 and the abnormal-time connection circuit 313. Then the monitor circuit 312 stops the output of the clear signal, resets the counter, and restarts the counting from the beginning.

The abnormal-time connection circuit 313 includes resistors R61 to R68, capacitors C61 and C62, diodes D61 to D63, an NPN-type transistor TR61, and P-type MOSFETs M61 and M62.

The gate of the MOSFET M61 is connected to the reset terminal of the CPU 311 through the resistor R31, the drain is connected to the anode of the diode D61, the source is connected to the cathode of the diode D61, and the resistor R62 is connected between the gate and the source. The resistor R63 and the capacitor C61 are connected in series between the drain of the MOSFET M61 and the anode of the diode D62. The resistors R64 and R65 are connected in series between the cathode of the diode D62 and the base of the transistor TR61. One end of the capacitor C62 is connected between the resistors R64 and R65, and the other end is connected to the ground.

The collector of the transistor TR61 is connected to a gate of the MOSFET M62 through the resistor R67, the emitter is connected to the ground, and the resistor R66 is connected between the base and the emitter. The drain of the MOSFET M62 is connected to the cathode of the diode D63 and one end of the coil La of the keep relay 215, the source is connected to the anode of the diode D63, and the resistor R68 is connected between the gate and the source.

An operation of the abnormal-time connection circuit 313 is described later.

The automatic stopping circuit 314 differs from the automatic stopping circuit 216 in FIG. 2 in that a diode D33 is added.

The anode of the diode D33 is connected between the resistors R64 and R65 of the abnormal-time connection circuit 313, the cathode is connected to the collector of the transistor TR31.

An operation of the automatic stopping circuit 314 is described later.

The electric-power supply monitor circuit 315 includes resistors R71 to R77, an NPN-type transistor TR71, a PNP-type transistor TR72, and a Zener diode ZD71.

The base of the transistor TR71 is connected to the monitoring setting output terminal of the CPU 311 through the resistor R72, the collector is connected to the base of the transistor TR72 through the resistor R73, the emitter is connected to the ground, and the resistor R72 is connected between the base and the emitter. The collector of the transistor TR72 is connected to the monitoring input terminal of the CPU 311 through the resistors R75 and R77, the emitter is connected between the contact a of the keep relay 215 and the load 103, and the resistor R74 is connected between the base and the emitter. One end of the resistor R76 is connected between the resistors R75 and R77, the other end is connected to the ground. The cathode of the Zener diode ZD71 is connected between the resistors R75 and R77, and the anode is connected to the ground.

An operation of the electric-power supply monitor circuit 315 is described later.

### [Operation of Power-Supply Management ECU 301]

An operation of the power-supply management ECU 301 will be described below. Only a portion in which the operation is different from that of the power-supply management ECU 201 is described, and overlapping description of a portion in which the operation is identical to that of the power-supply management ECU 201 is omitted as appropriate.

(The Case that Abnormality is Generated in CPU 311)

The operation in the case that the abnormality is generated in the CPU 311 will be described.

In the case that the CPU 311 is normally operated, the clear signal is periodically output from the output terminal of the CPU 311, and transmitted to the monitor circuit 312 to reset the counter of the monitor circuit 312. The exceedance is not generated in the counter of the monitor circuit 312, and the reset signal is not output. Therefore, the MOSFET M61, the transistor TR61, and the MOSFET M62 of the abnormal-time connection circuit 313 are kept in the off state. Because the MOSFET M62 is turned off, the abnormal-time connection circuit 313 does not output the connection signal.

On the other hand, in the case that the abnormality is generated in the CPU 311, the output of the clear signal is stopped, but the counter of the monitor circuit 312 is not reset. When the exceedance is generated in the counter of the monitor circuit 312, the single pulsed reset signal having the negative-true logic (low active) is output from the reset output terminal of the monitor circuit 312, and transmitted to the reset terminal of the CPU 311 and the abnormal-time connection circuit 313.

While the reset signal is transmitted, the MOSFET M61 of the abnormal-time connection circuit 313 is turned on, and the current is passed into the capacitor C62 from the power supply 102. Therefore, the charge is accumulated in the capacitor C62, the potential at a point P11 rises.

Then the monitor circuit 312 stops the output of the reset signal, resets the counter, and restarts the counting from the beginning. When the output of the reset signal is stopped, the MOSFET M61 is turned off to stop the supply of the current from the power supply 102 to the capacitor C62.

When receiving the reset signal, the CPU 311 is reset to the initial state by performing the restart. As a result, when returning to the normal state, the CPU 311 restarts the output of the clear signal, but the monitor circuit 312 does not output the reset signal. The charge accumulated in the capacitor C62 is discharged, and the potential at the point P11 is lowered to the original state.

On the other hand, when the abnormality of the CPU 311 is not resolved, the monitor circuit 312 repeats the exceedance of the counter because the output of the clear signal from the CPU 311 is still stopped. Every time the exceedance is generated in the counter, the monitor circuit 312 outputs the single pulsed reset signal, the MOSFET M61 is turned on, and the current is passed into the capacitor C62 from the power supply 102. Therefore, the charge amount accumulated in the capacitor C62 increases gradually. The operation is repeated predetermined times, and the potential at the point P11 becomes greater than or equal to a predetermined threshold. At this point, the transistor TR61 is turned on, and therefore the MOSFET M62 is turned on.

When the MOSFET M62 is turned on, the excitation current is passed through the diode D1 and the MOSFET M62 from the power supply 102, and passed through the coil La of the keep relay 215. That is, the connection signal is output from the abnormal-time connection circuit 313, and transmitted to the coil La. When the connection signal is transmitted to the coil La for at least a predetermined time, the movable contact MC moves and comes into contact with the contact a. Therefore, the supply of the electric power from the power supply 102 to the load 103 is started.

At this point, the electric power (the voltage and the current) supplied from the keep relay 215 to the load 103 is partially supplied to the automatic stopping circuit 314. The current is passed through the keep relay 215, the diode D31, and the resistors R31 and R32 from the power supply 102, and passed through the base of the transistor TR31, thereby turning on the transistor TR31. In other words, the transistor TR31 detects the supply of the electric power to the load 103.

When the transistor TR31 is turned on, the charge accumulated in the capacitor C62 of the abnormal-time connection circuit 313 flows to the ground through the diode D33 and the transistor TR31, and the potential at the point P11 is lowered. When the potential at the point P11 is less than the threshold, the transistor TR61 is turned off, and therefore the MOSFET M62 is turned off, thereby stopping the transmission of the connection signal to the coil La.

The supply of the electric power to the load 103 is continued, because the movable contact MC remains to be in contact with the contact a even after the supply of the connection signal is stopped. The connection signal is not transmitted to the coil La of the keep relay 215, because the on state of the transistor TR31 of the automatic stopping circuit 314 is maintained while the supply of the electric power to the load 103 is continued.

The transmission of the connection signal to the coil La of the keep relay 215 is continued, because the monitor circuit 312 periodically transmits the reset signal to the abnormal-time connection circuit 313 while the CPU 311 stops the output of the clear signal due to the unresolved emergency of the CPU 311.

On the other hand, when returning to the normal state, the CPU 311 restarts the output of the clear signal, but the monitor circuit 312 does not output the reset signal.

The supply of the electric power to the load 103 is continued, because the movable contact MC remains to be in contact with the contact a even after the supply of the connection signal is stopped.

As described above, in the case that the abnormality is generated in the CPU 311, the keep relay 215 is automatically set to and maintained in the connection state, so that the impossibility of the supply of the electric power to the load 103 is prevented. For example, the situation in which the vehicle running is adversely affected because the information stored in the memory of the ECU of the vehicle is erased or because loads, such as the lamp and the wiper, which are connected to the ECU, are not driven can be avoided.

The abnormality is generated in the CPU 311, the abnormal-time connection circuit 313 transmits the connection signal to the coil La of the keep relay 215, and the movable contact MC comes into contact with the contact a, thereby instantaneously stopping the transmission of the connection signal to the coil La. Therefore, the power consumption of the keep relay 215 can be suppressed, and the time for which the power supply 102 supplies the electric power can be lengthened.

(Operation of Electric-Power Supply Monitor Circuit 315)

An operation of the electric-power supply monitor circuit 315 will be described below.

While the checking instruction signal is transmitted from the monitoring setting output terminal of the CPU 311 to the electric-power supply monitor circuit 315, the transistor TR71 is turned on, and therefore the transistor TR72 is turned on.

At this point, when the movable contact MC of the keep relay 215 is in contact with the contact a to supply the electric power from the power supply 102 to the load 103, the electric power (the voltage and the current) supplied from the keep relay 215 to the load 103 is partially supplied to the electric-power supply monitor circuit 315. The voltage is applied from the power supply 102 to the monitoring input terminal of the CPU 311 through the keep relay 215, the transistor TR72, the resistor R75, and the resistor R77, and the input voltage at the monitoring input terminal is set to a predetermined level (high level). In other words, the electric-power supply monitor circuit 315 transmits the high-level electric-power supply monitoring signal to the CPU 311.

On the other hand, when the movable contact MC of the keep relay 215 is in contact with the contact b and the electric power is not supplied from the power supply 102 to the load 103, the input voltage at the monitoring input terminal of the CPU 311 is set to a ground level (low level). In other words, the electric-power supply monitor circuit 315 transmits the low-level electric-power supply monitoring signal to the CPU 311.

Thus, the existence or non-existence of the supply of the electric power to the load 103 can be monitored only while the CPU 311 transmits the checking instruction signal to the electric-power supply monitor circuit 315. Accordingly, the existence or non-existence of the supply of the electric power to the load 103 can be monitored only when needed.

### 2. Modifications

Modifications of the embodiments of the present invention will be described below.

For example, the power-supply management ECUs 201 to 301 are not necessarily provided with the keep relay 215 inside, but the keep relay 215 may be provided outside the power-supply management ECUs 201 to 301.

In one or more embodiments of the present invention, the two-winding type keep relay is used. Alternatively, any relay may be used, as long as the state of the contact is changed by transmitting a different kind of control signal (for example, the connection signal and the disconnection signal) and can be retained even if the transmission of the control signal is stopped. For example, a one-winding type keep relay may be used.

In addition to the vehicle, one or more embodiments of the present invention can be applied to an apparatus and a system, which control the supply of the electric power using the relay.

In one or more embodiments of the present invention, by way of example, the keep relay 215 is set to the disconnection state after the CPU 212 or CPU 311 outputs the plural pulsed disconnection instruction signals. Alternatively, for example, the keep relay 215 may be set to the disconnection state once the CPU 212 or CPU 311 outputs the disconnection instruction signal. Similarly, for example, the keep relay 215 may be set to the connection state once the monitor circuit 312 outputs the reset signal. On the other hand, for example, the keep relay 215 may be set to the connection state after the CPU 212 or CPU 311 outputs the plural pulsed connection instruction signals.

The sequence of pieces of processing can be performed by hardware or software. In the case that the sequence of pieces of processing is performed by the software, a program constituting the software is installed in a computer. At this point, examples of the computer include a computer incorporated in dedicated hardware and a general-purpose personal computer in which various functions can be performed by installing various programs.

In the configuration of the power-supply control device 111 in FIG. 1, the automatic stopping circuit 115 outputs the signal to the connection circuit 113 to stop the output of the connection signal. The configuration of one or more embodiments of the present invention is not limited to this configuration. Alternatively, the automatic stopping circuit 115 outputs the signal to the control circuit 111, and the control circuit 111 stops the output of the connection instruction signal, whereby the connection signal output from the connection circuit 113 may be stopped.

The program executed by the computer may be a program in which the processing is performed in time series along the sequence of one or more embodiments of the present invention, a program in which the pieces of processing are concurrently performed, or a program in which the processing is performed in necessary timing when a call is received.

As used herein, the term of the system means the entire apparatus including plural apparatuses or means. That is, the system means a set of plural structural elements (such as apparatus and modules (components)), but all the structural elements are not necessarily included in the same casing. Accordingly, both plural apparatus, which are individually accommodated in the casings and connected through a network, and one apparatus in which plural modules are accommodated in one casing are the system.

The present invention is not limited to the above embodiments, but various changes can be made without departing from the scope of the present invention. While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. A power-supply control device that controls supply of an electric power from a power supply of a vehicle to a load of the vehicle by controlling a relay, the relay switching electric connection between the power supply and the load, the relay being able to retain a state of a contact even if transmission of a control signal is stopped, the power-supply control device comprising:
a control circuit that controls the state of the contact of the relay;
a connection circuit that transmits a first control signal to the relay in order to put the contact of the relay into a first state in which the power supply and the load are connected to each other when the control circuit transmits a first instruction signal;
a disconnection circuit that transmits a second control signal to the relay in order to put the contact of the relay into a second state in which the power supply and the load are disconnected from each other when the control circuit transmits a second instruction signal; and
an automatic stopping circuit that is connected between the relay and the load, and stops the first control signal output from the connection circuit using a voltage or a current, which is supplied from the relay to the load.

2. The power-supply control device according to claim 1, wherein the automatic stopping circuit stops the first control signal output from the connection circuit by stopping the connection circuit input to the first instruction signal.

3. The power-supply control device according to claim 2,
wherein the connection circuit includes a first switching element that becomes an on state only while the control circuit transmits the first instruction signal, the first switching element causing the connection circuit to output the first control signal, and
wherein the automatic stopping circuit includes a second switching element that becomes the on state using the voltage or the current, which is supplied from the relay to the load, the second switching element putting the first switching element into an off state by conducting the first instruction signal output from the control circuit to the automatic stopping circuit before the first instruction signal is input to the connection circuit.

4. The power-supply control device according to claim 3, wherein the second switching element connects wiring between the control circuit and the first switching element to a ground when being in the on state.

5. The power-supply control device according to claim 1
wherein the relay includes a first coil and a second coil,
wherein the connection circuit is connected so as to transmit the first control signal to the first coil,
wherein the disconnection circuit is connected so as to transmit the second control signal to the second coil, and
wherein the relay becomes the first state when the first control signal is transmitted to the first coil, the relay maintaining the first state even if the transmission of the first control signal is stopped, and the relay becomes the second state when the second control signal is transmitted to the second coil, the relay maintaining the second state even if the transmission of the second control signal is stopped.

6. The power-supply control device according to claim 1, further comprising the relay.

7. The power-supply control device according to claim 2,
wherein the relay includes a first coil and a second coil,
wherein the connection circuit is connected so as to transmit the first control signal to the first coil,
wherein the disconnection circuit is connected so as to transmit the second control signal to the second coil, and
wherein the relay becomes the first state when the first control signal is transmitted to the first coil, the relay maintaining the first state even if the transmission of the first control signal is stopped, and the relay becomes the second state when the second control signal is transmitted to the second coil, the relay maintaining the second state even if the transmission of the second control signal is stopped.

8. The power-supply control device according to claim 3,
wherein the relay includes a first coil and a second coil,
wherein the connection circuit is connected so as to transmit the first control signal to the first coil,
wherein the disconnection circuit is connected so as to transmit the second control signal to the second coil, and
wherein the relay becomes the first state when the first control signal is transmitted to the first coil, the relay maintaining the first state even if the transmission of the first control signal is stopped, and the relay becomes the second state when the second control signal is transmitted to the second coil, the relay maintaining the second state even if the transmission of the second control signal is stopped.

9. The power-supply control device according to claim 4,
wherein the relay includes a first coil and a second coil,
wherein the connection circuit is connected so as to transmit the first control signal to the first coil,
wherein the disconnection circuit is connected so as to transmit the second control signal to the second coil, and
wherein the relay becomes the first state when the first control signal is transmitted to the first coil, the relay maintaining the first state even if the transmission of the first control signal is stopped, and the relay becomes the second state when the second control signal is transmitted to the second coil, the relay maintaining the second state even if the transmission of the second control signal is stopped.

10. The power-supply control device according to claim 2, further comprising the relay.

11. The power-supply control device according to claim 3, further comprising the relay.

12. The power-supply control device according to claim 4, further comprising the relay.

13. The power-supply control device according to claim 5, further comprising the relay.

14. The power-supply control device according to claim 7, further comprising the relay.

15. The power-supply control device according to claim 8, further comprising the relay.

16. The power-supply control device according to claim 9, further comprising the relay.
